(19) United States
(12) Patent Application Publication
(10) Pub. No.: US 2013/0239207 A1
(43) Pub. Date: Sep. 12, 2013

(54) INFORMATION RECORDING SYSTEM AND RECORDING MEDIUM

(71) Applicant: PANASONIC CORPORATION, Osaka (JP)

(72) Inventors: Takeshi OTSUKA, Hyogo (JP); Hideaki YAMASHITA, Kyoto (JP)

(73) Assignee: PANASONIC CORPORATION, Osaka (JP)

(21) Appl. No.: 13/780,483

(22) Filed: Feb. 28, 2013

(30) Foreign Application Priority Data
Mar. 9, 2012 (JP) 2012-052660
Feb. 15, 2013 (JP) 2013-028060

(51) Int. Cl. G06F 21/31

(52) U.S. Cl. CPC G06F 21/31
USPC 726/19

(57) ABSTRACT

An information recording system includes a recording medium and an information recording device. The information recording device has a group password manager for saving a group password used for a predetermined group and an identification ID of the group password; a password setter for registering the group password in a password register of the recording medium and registering the identification ID in a password related information storage; a password selector for reading the identification ID from the password related information storage of the recording medium and selecting a group password corresponding to the identification ID from at least one group password stored in the group password manager according to the identification ID; and a limitation cancel requester for inputting the password selected by the password selector in the password comparator of the recording medium.

### BACKGROUND

1. Technical Field

The present disclosure relates to an information recording system including a recording medium capable of limiting functions by password and an information recording device for controlling the recording medium.

2. Related Art

When one tries to access data recorded on recording media such as a memory card, some recording media may require the person to input a password to ensure safety of the data. However, inputting of password is troublesome.

JP-A-2004-030581 discloses a technology for allowing a user to avoid the troublesomeness of password input. Specifically, a default input password is stored in the information recording device and an access security password is stored in the recording medium. In the case where a password is not input by the user to use the recording medium in the information recording device, the default input password is compared with the access security password. When the default input password matches with the access security password, access limitation to the recording medium is lifted. As a result, the user is allowed to access the recording medium without inputting the password.

### SUMMARY

There is a case where a plurality of recording media belonging to different users is required to be used in a single camera recorder, for example. In that case, there is a need for avoiding troublesomeness of password input while ensuring security.

The present disclosure provides an information recording system and a recording medium capable of allowing a user to avoid troublesomeness of password input while ensuring security in the case where a plurality of recording media belonging to different users is required to be used in a single camera recorder, for example.

An information recording system according to the present disclosure including a recording medium capable of limiting function by password and an information recording device for controlling the recording medium.

The recording medium includes:

a password register operable to store an input password;

a password related information storage operable to store an identification ID of the input password;

a password comparator operable to compare a password input from the information recording device with a password stored in the password register; and

a function limiter operable to limit a function of the recording medium when the passwords compared in the password comparator do not match.

The information recording device includes:

a group password manager operable to store a group password used for a predetermined group and an identification ID of the group password;

a password setter operable to register the group password in the password register of the recording medium and register the identification ID in the password related information storage;

a password selector operable to read the identification ID from the password related information storage of the recording medium and select a group password corresponding to the identification ID from at least one group password stored in the group password manager; and

a limitation cancel requester operable to input the password selected by the password selector to the password comparator of the recording medium.

According to the present disclosure, when a plurality of recording media belonging to different users is required to be used in a single camera recorder, for example, the user is allowed to avoid troublesomeness of password input while ensuring security.

### BRIEF DESCRIPTION OF DRAWINGS

FIG. 1 is a diagram illustrating a use case of an information recording system;

FIG. 2 is a block diagram illustrating a configuration of the information recording system;

FIG. 3 is a diagram describing an example of command format output from an information recording device to a recording medium;

FIG. 4 is a table of function ID;

FIG. 5 is a diagram illustrating an example of state transition of passwords and encryption keys;

FIG. 6 is a table of identification IDs of passwords;

FIG. 7 is a flow chart for describing operations of the information recording system according to the present disclosure;

FIG. 8 is a diagram illustrating a configuration of a camera recorder as a user data processing section of the information recording device; and

FIGS. 9A to 9E are diagrams of a recording sequence in the camera recorder.

### DETAILED DESCRIPTION OF PREFERRED EMBODIMENT

Embodiments will be described below in detail with reference to the drawings as required. However, unnecessarily detailed description may be omitted. For example, detailed description of already known matters and redundant description of substantially the same configuration may be omitted. All of such omissions are for facilitating understanding by those skilled in the art by preventing the following description from becoming unnecessarily redundant.

The inventor (s) provide the attached drawings and the following description for those skilled in the art to fully understand the present disclosure and does not intend to limit the subject described in the claims by the attached drawings and the following description.

(Background of the Present Disclosure)

As prices of flash memories are decreasing and as flash memories are becoming faster, memory cards are becoming to principally record moving images not only in the consumer appliances field but also the field of audio-visual appliances for professional use.

The memory card is compact, light, and convenient, though, it is apt to be lost. The contents taken by a camera recorder for professional use contain such information as personal information and confidential information. Therefore, the memory card involves a high risk of contents leakage in case of loss of the memory card which contains the contents or in case of careless lending of the memory card to an outsider.

For that reason, it is demanded that the memory card has a function of preventing the taken contents from being reproduced in case of loss or in case of careless lending to an outsider.

As a technology for solving the problem, it has been known the technology called password lock by which a password is set to a memory card and when a password same as that set to the memory card is not input, access to the memory card is forbidden.

The password lock technology requires a user to input a password each time the memory card is powered on. However, in the professional use which requires recording to instantly start after the power-on, the password input involves troublesomeness.

JP-A-2004-030581 stores a default input password in the information recording device and an access security password in the recording medium as described above. In the case where a password is not input by the user to use the recording medium in the information recording device, the default input password is compared with the access security password. When the default input password matches with the access security password, access limitation to the recording medium is lifted. As a result, the user is allowed to access the recording medium without inputting the password.

However, a user sometimes wants to share a camera recorder or a recording medium with a plurality of groups. That is the case particularly in the professional field.

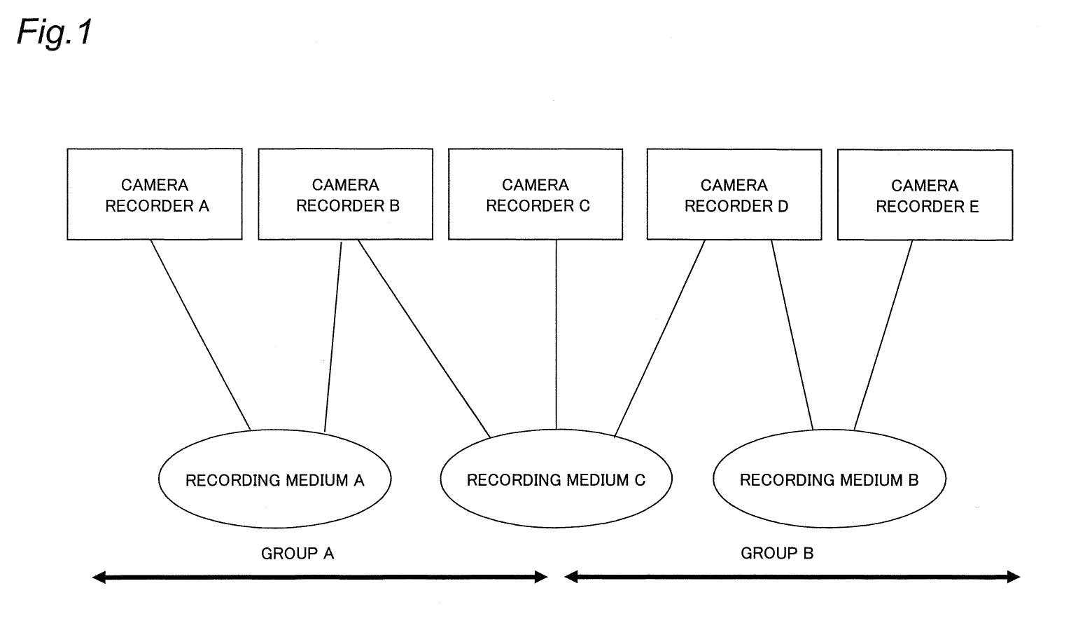

FIG. 1 is a diagram for describing an example of the case where a group A and a group B share camera recorders and recording media (recording medium). In the case illustrated in FIG. 1, the recording media includes a recording medium A used solely by the group A, a recording medium B used solely by the group B, and a recording medium C shared by the group A and the group B. The camera recorder includes a camera recorder a capable of using the recording medium A alone, a camera recorder b capable of using both the recording medium A and the recording medium C, a camera recorder c capable of using the recording medium C alone, a camera recorder d capable of using both the recording medium B and the recording medium C, and a camera recorder e capable of using the recording medium B alone.

In the camera recorder b and the camera recorder d, two kinds of recording media are used.

The problems of the prior art in the case illustrated in FIG. 1 will be described. Specifically, the problems in the case where individual passwords are provided to the recording medium A, the recording medium B, and the recording medium C and two kinds of passwords are registered as default passwords in the camera recorder b and the camera recorder d will be described.

As means for coping with the case illustrated in FIG. 1, it may be possible that the camera recorder b and the camera recorder d issue the two kinds of passwords in turn for specifying the recording medium to use.

However, in the case where the recording medium has the lock system which forbids the recording medium to accept the password when the passwords do not match, the above described method cannot to be used.

In the system which allows a user to reenter the password for a predetermined number of times when the passwords do not match, the recording medium to be used may possibly be specified by causing the passwords to be issued in turn. Yet, that increases the risk on security. In addition, since that increases the number of times of issuing the passwords, a time required to compare the passwords increases, growing the risk of missing a chance to photograph.

The present disclosure enhances the security function so that the content taken by a photographer other than the current user is not allowed to be reproduced in case of loss of the recording medium or in case of accidental lending of the recording medium to another group when the camera recorder or the recording medium is shared by a plurality of groups. Further, the present disclosure simplifies the procedure required to keep security.

(Outline of the Information Recording System of the Present Disclosure)

The present embodiment provides a group password manager for the information recording device, which constitutes the information recording system, so that the group password manager stores a group password shared for a predetermined group and the identification ID of the group password. The present embodiment also provides a password manager and a password related information storage for the recording medium to be used so that the group password is registered in the password register and the identification ID is registered in the password related information storage.

For example, when two groups of a group A and a group B cooperate with each other, it is assumed that there are three kinds of recording media such as a recording medium A used solely by the group A, a recording medium B used solely by the group B, and a recording medium C shared by the group A and the group B.

In that case, only the group passwords and the identification IDs of the recording medium A and the recording medium C are registered in the group password manager of the information recording device, and the group password and the identification ID of the recording medium B is left unregistered. As a result, an environment can be constructed such that the recording medium A and the recording medium C can be accessed but the recording medium B cannot be accessed.

That can keep security not only in the case where the recording medium A is lost but also in the case where the recording medium A is accidentally lent to the group B, because the recording medium A cannot be accessed by the camera recorder of the group B. Further, by using the recording medium C, the group A and the group B can cooperate with each other without being bothered by the troublesome password input. That can keep security also in the case where the recording medium C is lost because the recording medium C cannot be accessed by any group other than the group A and the group B.

### First Embodiment

### 1. Configuration

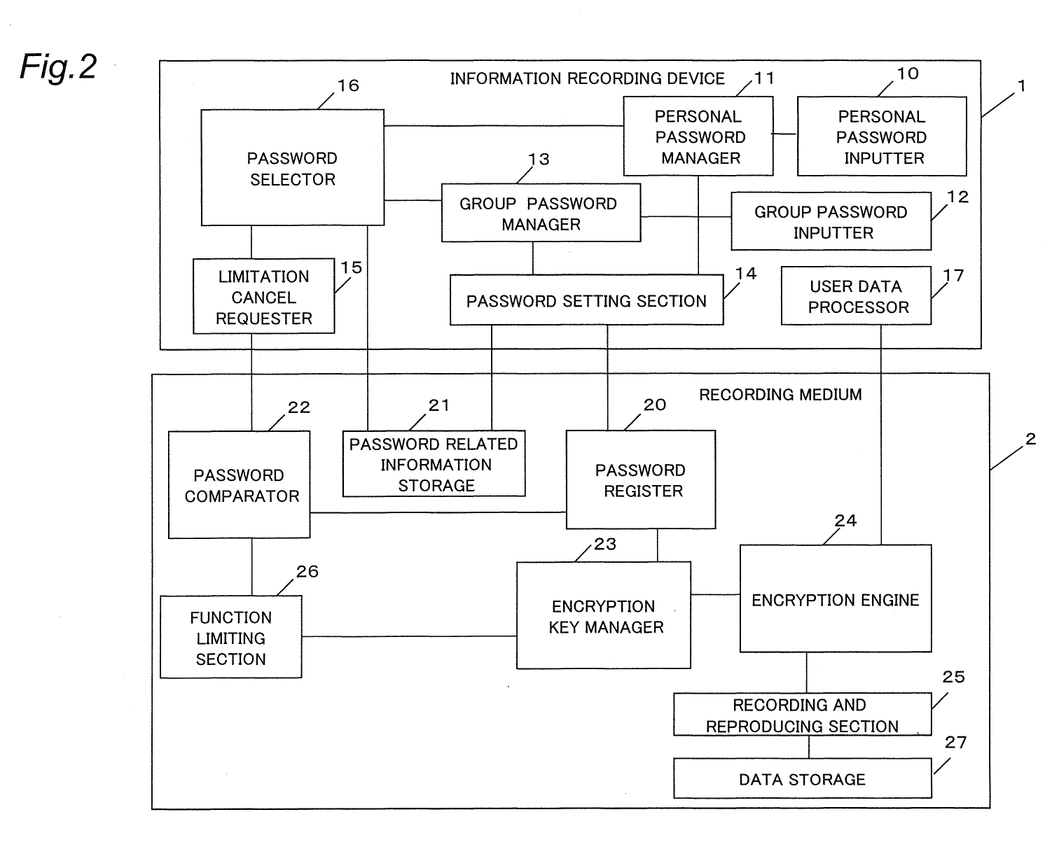

FIG. 2 is a block diagram illustrating a configuration of the information recording system which has the recording medium and the information recording device according to the present disclosure. The information recording device according to the present embodiment is applied to a camera recorder. As illustrated in FIG. 2, the information recording system according to the present disclosure includes an information recording device 1 and a recording medium 2.

1-1. Configuration of the Information Recording Device

The information recording device 1 includes a personal password inputter 10, a personal password manager 11, a group password inputter 12, a group password manager 13, a password setter 14, a limitation cancel requester 15, a password selector 16, and a user data processing section 17.

The personal password inputter 10 inputs a personal password from a software keyboard or the like.

The personal password manager 11 stores the personal password output from the personal password inputter 10. The personal password manager 11 stores (manages) at least two passwords of an initial password previously set in the recording medium 2 and the latest password input through the personal password inputter 10. The initial password is a password common to all of the groups including individual persons.

The group password inputter 12 connects to a predetermined server on the Internet via a network to obtain a group password. For example, the group password inputter 12 sends to the predetermined server such data as a serial number of the information recording device 1 and a number of the group to be set, and the predetermined server in turn generates a unique group password based on these numbers and sends the generated group password to the group password inputter 12 via a network. The group password is a password used by a group of a plurality of persons. The network needs to be secure, but, as the matter does not constitute an essential part of the present disclosure, description of the matter will be omitted.

The methods of inputting a password in the personal password inputter 10 and the group password inputter 12 are not limited to those described above. For example, the personal password inputter 10 may connect to a predetermined server on the Internet via a network to obtain a group password as the group password inputter 12 does. Conversely, the group password inputter 12 may input a group password through a software keyboard or the like as the personal password inputter 10 does.

The group password manager 13 stores (manages) the group password input through the group password inputter 12.

The password setter 14 sets passwords stored in the personal password manager 11 and the group password manager 13 as well as the related information of the passwords to the recording medium 2.

The password selector 16 selects a predetermined password from among the passwords managed by the personal password manager 11 or the group password manager 13 with reference to data in a password related information storage 21 (described later) of the recording medium 2 and outputs the selected password to the limitation cancel requester 15.

The limitation cancel requester 15 outputs to the recording medium 2 the password output from the password selector 16 and requires to lift the limitation on use of a predetermined function in the recording medium 2.

The user data processor 17 reads/writes user data including a video signal from/to the recording medium 2 according to a protocol for the storage such as ATA.

1-2. Configuration of the Recording Medium

The recording medium 2 includes a password register 20, a password related information storage 21, a password comparator 22, an encryption key manager 23, an encryption engine 24, a recording and reproducing section 25, and a function limiter 26.

The password register 20 stores a password output from the password setter 14 of the information recording device 1.

The password related information storage 21 stores related information associate d with the password. The related information stored in the password related information storage 21 can be read out by the information recording device 1.

The password comparator 22 compares a password output from the limitation cancel requester 15 with the password stored in the password register 20.

The encryption key manager 23 generates a common encryption key for performing an encryption process and a decryption process on the content, and manages the generated common encryption key. The encryption key manager 23 generates the common encryption key at random regardless of the password itself. Then, the encryption key manager 23 stores (manages) the generated common encryption key.

The encryption engine 24 encrypts the user data output from the user data processor 17 of the information recording device 1 and outputs the encrypted user data to the recording and reproducing section 25. Also, the encryption engine 24 decrypts the encrypted data reproduced by the recording and reproducing section 25 and outputs the data generated by the decryption to the user data processor 17 of the information recording device 1.

The recording and reproducing section 25 causes the data storage 27 to store the user data encrypted by the encryption engine 24. Also, the recording and reproducing section 25 reproduces the encrypted data stored in the data storage 27 and outputs it to the encryption engine 24.

The function limiter 26 puts a limit on use of the function of the recording medium 2 for the information recording device 1. Specifically, the function limiter 26 puts a limit on use of the function of the encryption key manager 23 of the recording medium 2 for the information recording device 1. When the result of comparing the passwords by the password comparator 22 shows that the passwords match, the function limiter 26 lifts the limitation on use of the function of the recording medium 2, and when the result shows that the passwords unmatch, the function limiter 26 does not lift the limitation on use of the function of the recording medium 2. Therefore, when the passwords unmatch, the information recording device 1 can neither read the content which is encrypted and stored in the recording medium 2 nor encrypt and record the user data output from the user data processor 17 of the information recording device 1 to the recording and reproducing section 25.

The data storage 27 stores the user data output from the recording and reproducing section 25. The data storage 27 is made up of a nonvolatile memory, a hard disk drive (HDD), and the like, for example.

1-3. Command

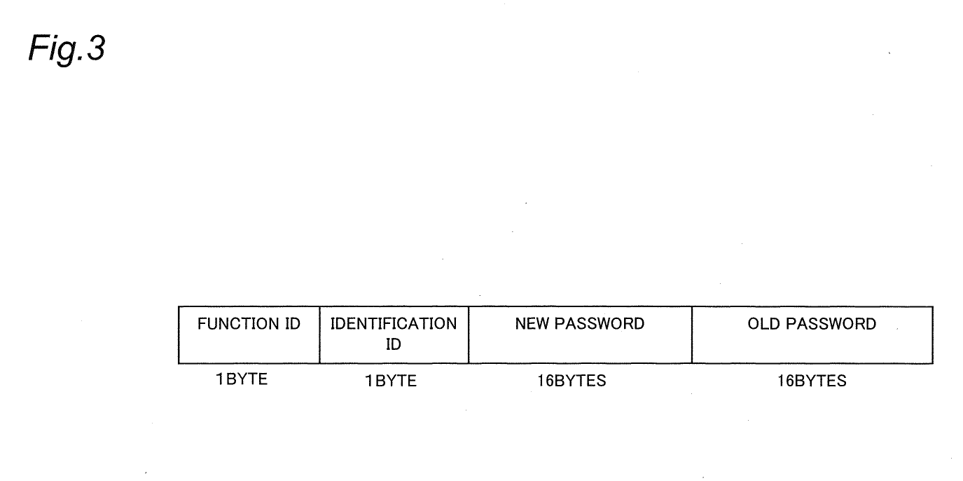

FIG. 3 is a diagram describing an example of command format output from the information recording device to the recording medium according to the present disclosure. The command includes a function ID, an identification ID, a new password after change, and the current password (old password). The function ID, the identification ID, the new password, and the old password have the amounts of information of 1 Byte, 1 Byte, 16 Byte, and 16 Byte, respectively. The identification ID, the new password, and the old password may not accompany some kinds of function IDs.

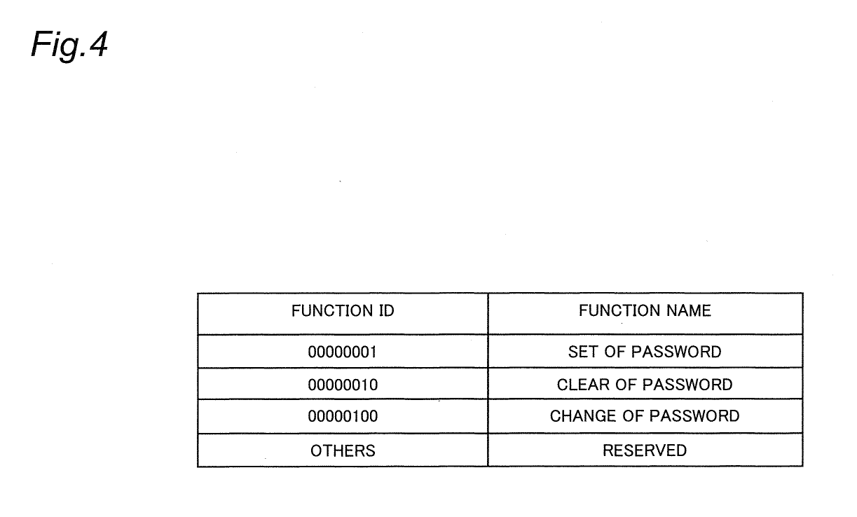

FIG. 4 is an illustration of function IDs related to passwords. In the present embodiment, “00000001”, “00000010”, “00000100” are set as the function IDs. The function IDs “00000001”, “00000010”, “00000100” correspond to a password setting function, a password clearing function, and a password changing function, respectively.

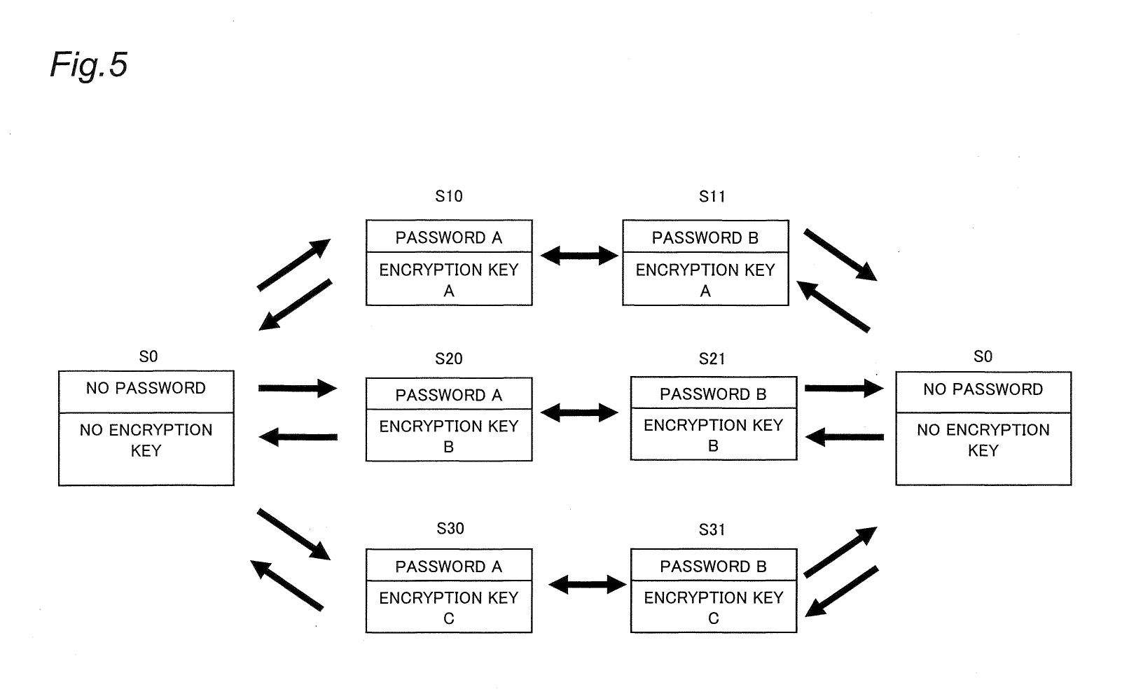

FIG. 5 is an illustration of state transition of passwords and encryption keys. The state S0 indicates a state in which the password is cleared and the encryption key is also cleared. It is possible to change any of the other states to the state S0 by issuing a command with the password clearing function ID added. In the password clearing command, any of the identification ID, the new password, and the old password needs not to accompany the function ID.

When a command with the password setting function ID added (password setting command) is issued in the state S0, an encryption key is generated and the state changes to the state other than the state S0 (S10, S20, S30, S11, S21, S31,). In the password setting command, the identification ID and the new password accompany the function ID.

When a command with the password clearing function ID added (password clearing command) is issued in the state other than the state S0 (S10, S20, S30, S11, S21, S31,), the state changes to the state S0 in which the password and the encryption key are cleared.

The states (S10, S20, S30) have the same password A and different encryption keys. The states S10, S20, S30 have an encryption key A, an encryption key B, an encryption key C, respectively. The states (S11, S21, S31) have the same password B and different encryption keys.

In order to change the password without changing the encryption key, a command with the password changing function ID added (password changing command) is issued in the state other than the state S0 in which the password and the encryption key are present. In the password changing command, the identification ID, the new password, and the old password accompany the function ID.

For example, when the password changing command is issued in the state S10, the state is enabled to be changed to the state S20 in which only the password is changed from the password A to the password B with the encryption key A left unchanged.

As described above, in the present embodiment, the encryption key does not change even though the password is changed. Therefore, it is also possible to change the password in the manner that the password registered in the information recording device 1 is issued to the recording medium 2, and in the recording medium 2, the issued password is compared with the password in the recording medium 2, and then the recording is started, and after the recording is started, a new password is input from the information recording device 1 to change the password.

1-4. Identification ID

The identification ID is 8 bits. The identification ID “00000000” indicates that the password included in the above described respective commands is the initial password of factory default. The identification ID “11111111” indicates that the password included in the above described respective commands is a personal password. The identification IDs “00000001” to “11111110” indicate that the password included in the above described respective commands is a group password. The identification ID is supplied by the number of 254 from “00000001” to “11111110”.

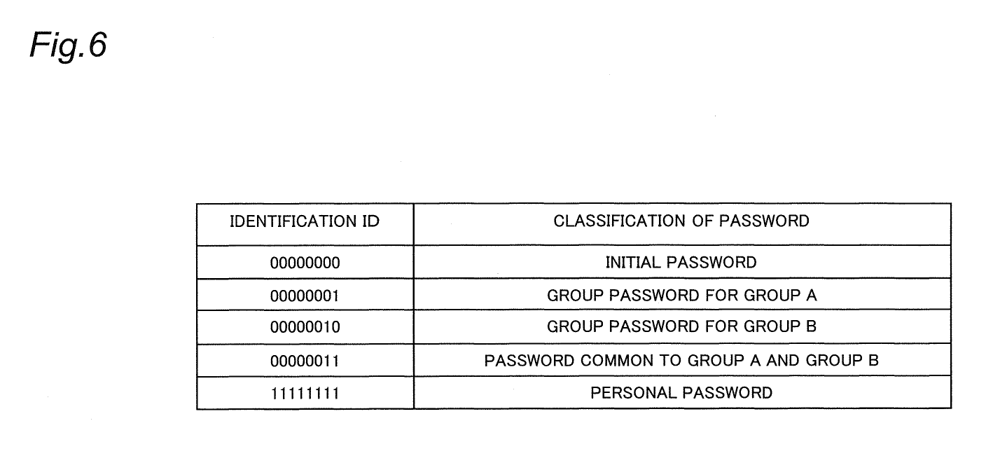

FIG. 6 shows a setting example of identification IDs. Specifically, FIG. 6 shows a setting example of identification IDs in the case where two groups of the group A and the group B are present as illustrated in FIG. 1. In this example, the identification ID “00000001” indicates that the password included in the above described respective commands is the group password for the group A, the identification ID “00000010” indicates that the password included in the above described respective commands is the group password for the group B, and the identification ID “00000011” indicates that the password included in the above described respective commands is the password common to the group A and the group B.

In the recording medium 2 in the ex-factory condition, the initial password is set to the password register 20. When the recording medium 2 is used for the first time, the information recording device 1 connects to a predetermined password managing server via a network by the group password inputter 12 to obtain the group password. When the information recording device 1 obtains the group password, it replaces the initial password set to the password register 20 of the recording medium 2 by the obtained group password.

1-5. Setting of Password to the Information Recording Device

The password according to the recording medium 2 to be used in the information recording device 1 is registered in the information recording device 1. When the recording medium 2 is to be in personal use, the personal password is registered in the personal password manager 11 via the personal password inputter 10. When the recording medium 2 is to be in group use, the group password is registered in the group password manager 12 via the group password inputter 12. When the recording medium 2 is to be used by a plurality of groups, the group password is registered in the group password manager 12 via the group password inputter 12. An example of registering the group password to the group password manager 13 of the information recording device 1 will be described with reference to FIG. 1.

In the case illustrated in FIG. 1, the recording medium A is used solely by the group A, the recording medium B is used by the group A and the group B, and the recording medium C is used solely by the group B.

In the camera recorder a, only the recording media A which is solely used by the group A is used. Therefore, the group password and the identification ID of the group A are registered in the camera recorder a.

In the camera recorder b, the recording media A which is solely used by the group A and the recording media B which is used by the group A and the group B are used. Therefore, the group password and identification ID of the group A and the common pas sword and identification ID of the group A and the group B are registered in the camera recorder b.

In the camera recorder c, only the recording media B which is used by the group A and the group B is used. Therefore, the common password and identification ID of the group A and the group B are registered in the camera recorder c.

In the camera recorder d, the recording media B which is used by the group A and the group B and the recording media C which is solely used by the group B are used. Therefore, the common password and identification ID of the group A and the group B and the password and identification ID of the group B are registered in the camera recorder d.

In the camera recorder e, only the recording media C which is solely used by the group B is used. Therefore, the group password and identification ID of the group B are registered in the camera recorder e.

1-6. Use of the Recording Medium in the Ex-Factory Condition

For example, when the recording medium in the ex-factory condition is to be used as the recording medium A dedicated to the group A in the camera recorder b, the initial password and identification ID set to the recording medium are replaced by the password and identification ID of the group A. Also, when the recording medium in the ex-factory condition is to be used as the recording medium B common to the group A and the group B, the initial password and identification ID set to the recording medium are replaced by the password and identification ID common to the group A and the group B.

The password and identification ID set to the recording medium 2 via the password setter 14 of the information recording device 1 are stored in the password register 20 and the password related information storage 21 of the recording medium 2.

1-7. Comparing of Passwords by the Recording Medium

The operations of comparing passwords performed by the recording medium 2 to which a password is set will be described below. In the camera recorder b illustrated in FIG. 1, four kinds of passwords such as the initial password, the group password of the group A, the common password of the group A and the group B, and the personal password are stored as previously known passwords with the respective identification IDs. The personal password is stored in the personal password manager 11. The group password is stored in the group password manager 13.

When the recording medium 2 is inserted into the information recording device 1 (camera recorder), the password selector 16 of the information recording device 1 reads the identification ID stored in the password related information storage 21 of the recording medium 2. The password selector 16 selects the password of the recording medium 2 from the personal password manager 11 or the group password manager 13 based on the identification ID. When the password is selected, the password selector 16 outputs the password to the password comparator 22 of the recording medium 2 via the limitation cancel requester 15. The password comparator 22 performs comparison on the password output from the limitation cancel requester 15.

1-8. Operations of the Information Recording System

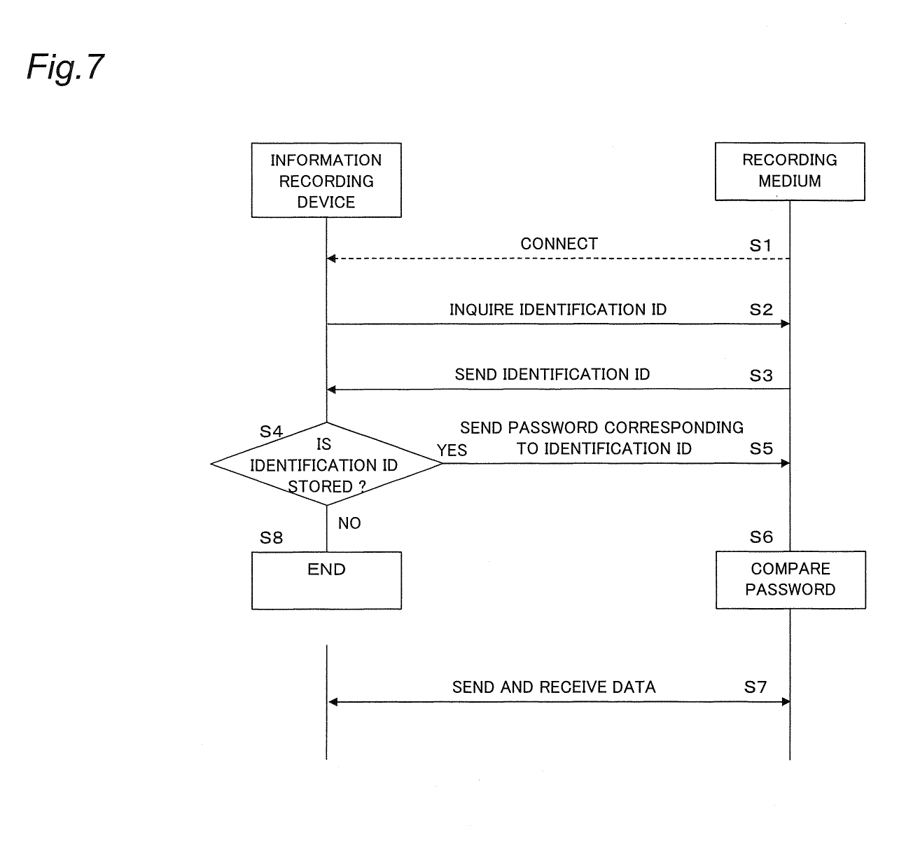

FIG. 7 is a flow chart for describing operations of the information recording system according to the present disclosure.

When the recording medium 2 is connected to the information recording device 1 (S1), the information recording device 1 inquires the identification ID to the recording medium 2 (S2). When the recording medium 2 receives the inquiry about the identification ID, it sends the identification ID of the recording medium 2 to the information recording device 1 (S3). When the information recording device 1 receives the identification ID, it checks whether the password corresponding to the identification ID is stored in the personal password manager 11 or the group password manager 13 (S4), and when the password is stored, it sends the password corresponding to the identification ID to the recording medium 2 (S5). When the recording medium 2 receives the password from the information recording device 1, it compares the received password with the password stored in the password register 20 (S6). When the passwords match, the recording medium 2 can send and receive data between itself and the information recording device 1. On the other hand, when the password corresponding to the identification ID is not stored in step S4, the information recording device 1 finishes the processing without sending the password corresponding to the identification ID to the recording medium 2.

1-9. Specific Example of the Information Recording Device

1-9-1. Configuration

A specific example of the information recording device 1 will be described. The present example will be described on the assumption that the camera recorder includes the information recording device 1 and the user data processor 17 of the information recording device 1 is an image generating/recording section of the camera recorder.

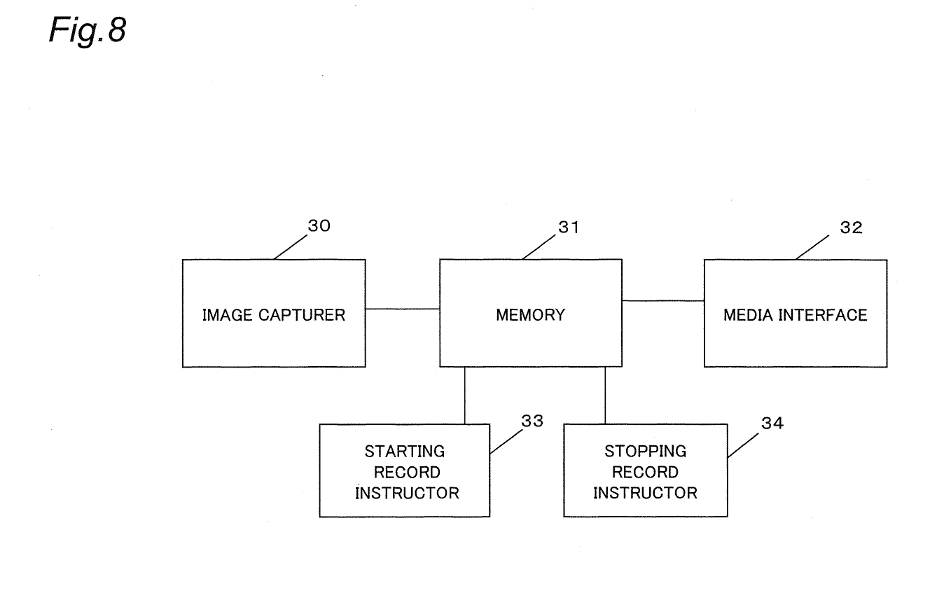

FIG. 8 is a block diagram illustrating a configuration of the image generating/recording section of the camera recorder as the user data processor 17.

The user data processor 17 has an image capturer 30, a memory 31, a media interface 32, a starting record instructor 33, and a stopping record instructor 34.

The image capturer 30 has a lens and a CMOS sensor. The image capturer 30 captures an image of the subject to generate and output digital image data.

The memory 31 temporarily stores the digital image data generated by the image capturer 30. The memory 31 has an enough memory capacity to store the digital image data taken for, for example, one minute, and is to be used as a ring memory. The memory 31 stores the digital image data taken for one minute till the present moment by performing ring memory control to overwrite the digital image data on the memory address where the digital image data taken at one minute before the present moment is stored with the digital image data of the present moment.

The media interface 32 reads the digital image data from the memory 31 and converts the read out digital image data into an interface format for the recording medium such as the ATA protocol.

The starting record instructor 33 is an interface for a user to provide an instruction to execute the recording. The starting record instructor 33 is the “REC” button, for example.

The stopping record instructor 34 is an interface for a user to provide an instruction to stop the recording. The stopping record instructor 34 is the “STOP” button, for example.

1-9-2. Recording Sequence in the Camera Recorder

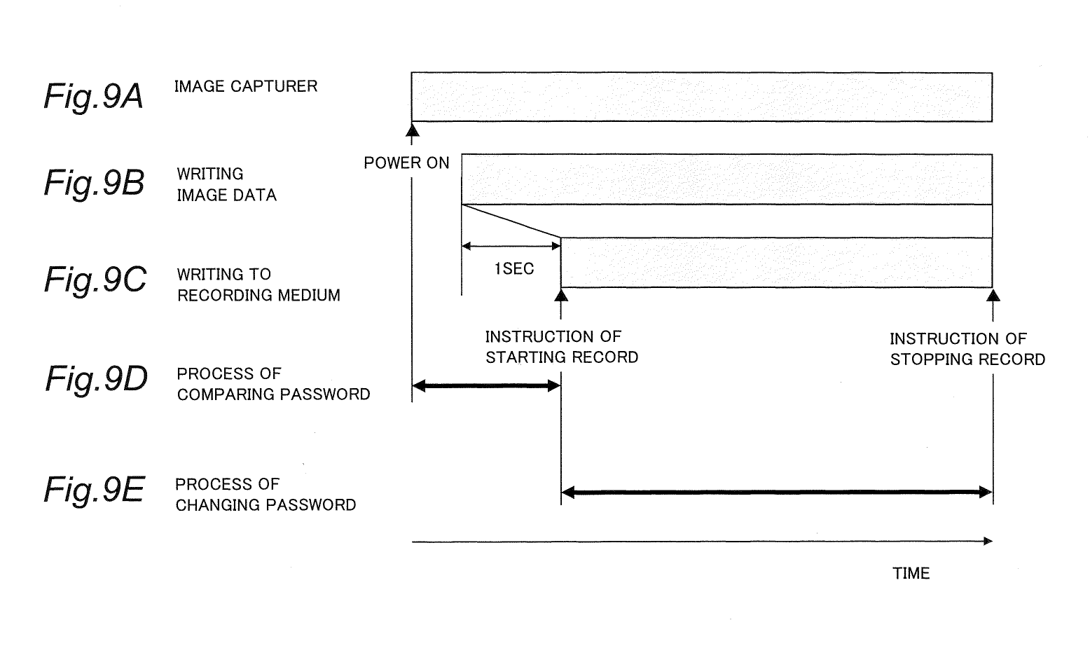

In a professional use, it is fatal to miss an important chance to shoot, therefore, it is needed to omit such a task of inputting a password as much as possible. FIG. 9 is a diagram of a recording sequence in the camera recorder. FIG. 9A is a diagram illustrating a period in which digital image data is output from the image capturer 30. As soon as the camera recorder is powered on, the image capturer 30 starts outputting the digital image data. FIG. 9B is a diagram illustrating a period in which the digital image data is written into the recording medium. The camera recorder records the digital image data from one second before the starting record instruction to the stopping record instruction in the recording medium. FIG. 9C illustrates a period in which the digital image data is recorded into the recording medium. The digital image data is recorded between the starting record instruction and the stopping record instruction.

As illustrated in FIGS. 9B and 9C, the camera recorder of the present embodiment uses the memory 31 as a ring memory for the digital image data, reads out the digital image data from one second before the starting record instruction which is recorded in the memory 31 at higher speed than real time, and writes the digital image data into the recording medium 2, so that the digital image data from one second before the starting record instruction can be recorded.

FIG. 9D illustrates a period in which password comparing is available. The password comparing is available from the moment of power-on to the moment of the starting record instruction. In the case where the password comparing is practiced after the starting record instruction, the actual moment to start recording delays by the comparing time period. FIG. 9E illustrates a period in which password changing is available.

For example, in the case where it is desired to change the initial password of the recording medium 2 to the group password, in the period in which password changing is available, the initial password is used for the password comparing for the recording medium 2, and then the recording of the digital image data is started, and during or after the recording of the digital image data, the password of the recording medium 2 may be changed to the group password. As described above, in the present embodiment, since the password is for managing the encryption key, the encryption key is left unchanged even though the password is changed. Therefore, the password is allowed to be changed during the recording of the digital image data.

By causing the camera recorder to perform the recording in the above described sequence, the task of inputting a password on the keyboard can be omitted in the event of changing of the initial password to another password and in the event of comparing of the passwords. That is, the task of inputting a password on the keyboard can be omitted twice. Further, since the password comparing is practiced before the starting record instruction by using a password already registered in the camera recorder, the user does not miss a chance to shoot by the camera recorder.

1-10. Summarization

As described above, the information recording system according to this disclosure includes the information recording device 1 and the recording medium 2 which encrypts to record data. The group password manager 13 of the information recording device 1 stores a group password shared for a predetermined group and an identification ID of the group password. The password register 20 of the recording medium 2 stores the group password, and the password related information storage 21 stores the identification ID. When the information recording device 1 is powered on (power-on) or has the recording medium 2 inserted, it reads out the identification ID registered in the password related information storage 21 and outputs the identification ID to the recording medium 2, which in turn searches for the password corresponding to the identification ID and performs the password comparing task.

By previously registering the passwords and the identification IDs of the passwords in the information recording device 1 in a case where a plurality of passwords are present, a time required to input the password can be reduced, thus, the shooting goes on efficiently.

Further, by registering the common password of a plurality of groups and the identification ID of the common password in the group password manager 13, the plurality of groups can use the common recording medium 2. Since the shot content is encrypted before recording, a risk of having the content shot by the plurality of groups reproduced by a group other than the plurality of groups can be reduced, even though the recording medium 2 is accidentally lent to the group other than the plurality of groups.

Further, by accumulating the digital image data input from the image capturer 30 in the memory 31 in the camera recorder, performing the password comparing task before the starting record instruction, and replacing the password with another one in the recording, the task for the user to input a password to start recording can be omitted. In addition, the fact that the camera recorder is comparing the passwords is not recognized by the user.

Although the group password management for two groups has been described in the present embodiment, it is needless to say that the embodiment may be applied to the case of N groups (N is an integral number 2 or more).

Although the identification ID has been described as 8 bits, the number of bits of the identification ID may be increased so that more number of groups share the password. Further, the number of bits of the identification ID may be increased so that access limitation on the recording medium 2 is set in detail.

Meanwhile, the capacity of the memory incorporated in the camera recorder is not limited to one minute. The capacity may be more or less than one minute.

### 2. Effects and the Like of the Present Disclosure

As described above, according to the present embodiment,

the information recording system including the recording medium 2 capable of limiting function by password and the information recording device 1 for controlling the recording medium 2 are provided.

The recording medium 2 includes:

a password register 20 for saving an input password;

a password related information storage 21 for saving an identification ID of the input password;

a password comparator 22 for comparing a password input from the information recording device 1 with a password stored in the password register 20; and

function limiter 26 for limiting a function of the recording medium 2 when the passwords compared in the password comparator 22 do not match, and

the information recording device 1 includes:

a group password manager 13 for saving a group password used for a predetermined group and an identification ID of the group password;

a password setter 14 for registering the group password in the password register 20 of the recording medium 2 and registering the identification ID in the password related information storage 21;

a password selector 16 for reading the identification ID from the password related information storage 21 of the recording medium 2 and selecting a group password corresponding to the identification ID from at least one group password stored in the group password manager 13 according to the identification ID; and

a limitation cancel requester 15 for inputting the password selected by the password selector 16 in the password comparator 22 of the recording medium 2.

With this configuration, when a plurality of recording media 2 belonging to different users is used in a single camera recorder, for example, the present embodiment allows the user to avoid troublesomeness of password input while ensuring security.

Further, in the present embodiment,

the information recording device 1 further includes:

a group password inputter 12 for inputting the group password and the identification ID of the group password.

With this configuration, the group password and the identification ID of the group password can be changed.

Further, in the present embodiment,

the information recording device 1 further includes:

a personal password inputter 10 for allowing a user to set a personal password; and

a personal password manager 11 for saving the password input by the personal password inputter 10 and the identification ID of the personal password, wherein

the password selector 16 reads the identification ID from the password related information storage 21 of the recording medium 2 and selects the group password corresponding to the identification ID from at least one group password stored in the group password manager 13 according to the identification ID or selects the personal password corresponding to the identification ID from at least a personal password stored in the personal password manager 11.

With this configuration, the personal password can be set in addition to the group password.

Further, in the present embodiment,

the group password manager 13 stores an initial password common to all of groups and the identification ID of the initial password.

With this configuration, by saving in the recording medium 2 an initial password common to all of groups and the identification ID of the initial password stored in the group password manager 13 as the initial password of the recording medium 2, the embodiment can quickly start the recording when the recording medium 2 is used for the first time.

Further, in the present embodiment,

the recording medium 2 further includes:

an encryption key manager 23 for generating and managing an encryption key; and

an encryption engine 24 for performing encryption of data and decryption of encrypted data by using the encryption key, and

the function limiter 26 limits a function associated with the encryption or the decryption of the encryption engine 24.

With this configuration, the most important security function associated with the encryption or the decryption can be limited.

Further, in the present embodiment,

the encryption key manager 23

disables the encryption key by clearing the password registered in the password register 20 and generates the encryption key by registering a password in the state that the password registered in the password register 20 is cleared, and does not update the encryption key even though the password which is already registered in the password register 20 is changed.

With this configuration, the embodiment can disable the encryption key by clearing the password and generate the encryption key by registering a password in the state that the password registered in the password register 20 is cleared. Also, since the embodiment does not update the encryption key even though the password which is already registered in the password register is changed, it does not become unable to perform encryption and decryption even though the password is changed.

Further, in the present embodiment,

the recording medium 2 further includes:

a data storage 27; and

a recording and reproducing section 25 for causing the data storage 27 to store encrypted data which is encrypted in the encryption engine 24 and reproducing the encrypted data stored in the data storage 27, wherein

the password comparator 22 compares an initial password registered in the group password manager 13 or the personal password manager 11 with an initial password stored in the same kind of password register 20 of the recording medium 2 as that the first initial password to be matched,

the recording and reproducing section 25 starts recording after the comparison is made by the password comparator 22, and

in the case where a new password is input through the personal password inputter 10 or the group password inputter 12 while the recording and reproducing section 25 is in the process of recording, the password setter 14 inputs the new password into the recording medium 2 and the password register 20 replaces the password in the recording medium 2 by the new password while the recording and reproducing section 25 is in the process of recording or after the recording and reproducing section 25 completed the recording.

With this configuration, after an initial password registered in the group password manager 13 or the personal password manager 11 is compared with the initial password stored in the same kind of password register 20 of the recording medium 2 as that the first initial password is registered, the user is allowed to start recording. Afterwards, the user is allowed to change the password.

Further, the present embodiment further includes:

an image capturer 30 for capturing an image;

a starting record instructor 33 for receiving from the user an instruction to start recording of image data which is output from the image capturer 30;

a stopping record instructor 34 for receiving from the user an instruction to stop the recording of image data which is input from the image capturer 30; and

a memory 31 for storing image data for a predetermined period which is input through the image capturer 30 before an instruction to start recording is issued to the starting record instructor 33, wherein

the password comparator 22 compares the password registered in the group password manager 13 or the personal password manager 11 with the password stored in the password register 20 of the recording medium 20 before the instruction to start recording is issued.

With this configuration, an image before an instruction to start recording is issued to the starting record instructor 33 can be recorded.

Further, the present embodiment provides the recording medium 2.

The recording medium 2 includes:

a password register 20 for saving an input password;

a password related information storage 21 for saving an identification ID of the input password;

a password comparator 22 for comparing a password stored in the password register 20 with a password input; and

a function limiter 26 for limiting a function of the recording medium 2 when the passwords compared in the password comparator 22 do not match, and

a group password used for a predetermined group is registered in the password register 20 and

an identification ID of the group password is registered in the password related information storage 21.

With this configuration, the present embodiment can provide the information recording system capable of allowing the user to avoid troublesomeness of password input while ensuring security in the case where a plurality of recording media 2 belonging to different users is used in a single camera recorder, for example.

Further, in the present embodiment,

the recording medium 2 includes:

an encryption key manager 23 for managing an encryption key; and

an encryption engine 24 for performing encryption of data and decryption of encrypted data by using the encryption key, and

the function limiter 26 limits a function associated with the encryption or the decryption of the encryption engine 24.

With this configuration, the most important security function associated with the encryption or the decryption can be limited.

Further, in the recording medium 2 of the present embodiment,

the encryption key manager 23

disables the encryption key by clearing the password registered in the password register 20,

generates the encryption key by registering a password in the state that the password in the password register 20 is cleared, and

does not update the encryption key even though the password which is already registered in the password register 20 is changed.

With this configuration, the embodiment can disable the encryption key by clearing the password and generate the encryption key by registering a password in the state that the password registered in the password register 20 is cleared. Also, since the embodiment does not update the encryption key even though the password which is already registered in the password register is changed, it does not become unable to perform encryption and decryption even though the password is changed.

### Other Embodiments

The personal password inputter, the personal password manager, the group password inputter, the group password manager, the password setter, the limitation cancel requester, the password selector, and the user data processor constituting the information recording device 1, and the password register, the password related information storage, the password comparator, the encryption key manager, the encryption engine, the recording and reproducing section, and the function limiter constituting the recording medium 2 may be separately made into individual chips or may be made into chips which include some or all of the functional blocks by such a semiconductor device as LSI.

Although LSI is used as the semiconductor device here, the semiconductor device may be referred to as IC, system LSI, super LSI, ultra LSI according to the integration density.

Further, the technique of making the above described functional blocks into an integrated circuit is not limited to LSI, and the integrated circuit may be implemented by a dedicated circuit or a general purpose processor. A FPGA (Field Programmable Gate Array) which is capable of programming the manufactured LSI or a reconfigurable processor which is capable of reconfiguring connection and setting of the circuit cells inside the LSI may be used.

Furthermore, when a new technology to make the functional blocks into an integrated circuit is developed to replace the LSI as advancement or derivation of the semiconductor technology, the new technology may be used in making the functional blocks into an integrated circuit. Application of such technology as biotechnology can be considered.

Each processing of the embodiments may be practiced by hardware, or may be practiced by software (including the case the processing is practiced with an OS (operating system), middleware, or a predetermined library). In addition, each processing may be practiced by mixed processing (cooperation) of software and hardware. That is, since the information recording device 1 and the recording medium 2 have a processor and a memory storing programs, the functions of the above described respective components may be practiced by the processor executing the programs on the memory.

The embodiments have been described above as examples of the technology of the present disclosure. For those examples, the attached drawings and the detailed description have been provided.

Consequently, in order to exemplify the above described technology, the constituent elements shown in the attached drawings and described in the detailed description may include not only a constituent element which is necessary to solve the problem but also a constituent element which is not necessary to solve the problem. Therefore, the unnecessary constituent element should not be instantly recognized as a necessary constituent element merely because it is shown in the attached drawings and described in the detailed description.

Also, since the above described embodiments are for exemplifying the technology of the present disclosure, various changes, substitutions, addition, omission and the like may be performed on the embodiments without departing from the scope of the claims and the equivalent of the claims. In addition, the respective constituent elements described in the first embodiment may be combined to make a new embodiment.

### INDUSTRIAL APPLICABILITY

Since the information recording device and the recording medium according to the present disclosure encrypt to record data, they can reduce the risk in the event that the recording medium is lost. Moreover, a plurality of groups may share the appliance and the recording medium. Also, the task of inputting a password to practice data encryption can be significantly reduced. Therefore, the information recording device and the recording medium according to the present disclosure may be highly possible to be used in the field of camera recorder for professional use, for which it is not allowed to miss an important chance to photograph.

What is claimed is:

1. An information recording system including a recording medium capable of limiting function by password and an information recording device for controlling the recording medium, wherein
the recording medium comprises:
a password register operable to store an input password;
a password related information storage operable to store an identification ID of the input password;
a password comparator operable to compare a password input from the information recording device with a password stored in the password register; and
a function limiter operable to limit a function of the recording medium when the passwords compared in the password comparator do not match, and
the information recording device comprises:
a group password manager operable to store a group password used for a predetermined group and an identification ID of the group password;
a password setter operable to register the group password in the password register of the recording medium and register the identification ID in the password related information storage;
a password selector operable to read the identification ID from the password related information storage of the recording medium and select a group password corresponding to the identification ID from at least one group password stored in the group password manager; and
a limitation cancel requester operable to input the password selected by the password selector to the password comparator of the recording medium.

2. The information recording system according to claim 1, wherein the information recording device further comprises:
a group password inputter operable to input the group password and the identification ID of the group password.

3. The information recording system according to claim 1, wherein the information recording device further comprises:
a personal password inputter operable to allow a user to set a personal password; and
a personal password manager operable to store the password input from the personal password inputter and the identification ID of the personal password, wherein
the password selector reads the identification ID from the password related information storage of the recording medium and selects the group password corresponding to the identification ID from at least one group password stored in the group password manager according to the identification ID or selects the personal password corresponding to the identification ID from at least a personal password stored in the personal password manager.

4. The information recording system according to claim 2, wherein the group password manager stores an initial password common to all of groups and the identification ID of the initial password.

5. The information recording system according to claim 1, wherein the recording medium further comprises:
an encryption key manager operable to generate and managing an encryption key; and
an encryption engine operable to perform encryption of data and decryption of encrypted data by using the encryption key, and
the function limiter limits a function associated with the encryption or the decryption of the encryption engine.

6. The information recording system according to claim 5, wherein
the encryption key manager
disables the encryption key by clearing the password stored in the password register and generates the encryption key by registering a password in the state that the password stored in the password register is cleared, and
does not update the encryption key even though the password which is already stored in the password register is changed.

7. The information recording system according to claim 6, wherein the recording medium further comprises:
a data storage; and
a recording and reproducing section operable to cause the data storage to store encrypted data which is encrypted in the encryption engine and reproduce the encrypted data stored in the data storage, wherein
the password comparator compares an initial password stored in the group password manager or the personal password manager with an initial password stored in the same kind of password register of the recording medium as that storing the initial password to be matched,
the recording and reproducing section starts recording after the comparison is made by the password comparator, and
in the case where a new password is input through the personal password inputter or the group password inputter while the recording and reproducing section is in the process of recording, the password setter sets the new password into the recording medium and the password register replaces the password in the recording medium by the new password while the recording and reproducing section is in the process of recording or after the recording and reproducing section completes the recording.

8. The information recording system according to claim 7, further comprising:
an image capturer operable to capture an image;
a starting record instructor operable to receive an instruction to start recording of image data which is output from the image capturer from a user;
a stopping record instructor operable to receive from the user an instruction to stop the recording of image data which is input from the image capturer; and
a memory operable to store image data which is input for a predetermined period through the image capturer before the instruction to start recording is issued to the starting record instructor, wherein
the password comparator compares the password registered in the group password manager or the personal password manager with the password stored in the password register of the recording medium before the instruction to start recording is issued.

9. A recording medium comprising:
a password register for saving an input password;
a password related information storage operable to store an identification ID of the input password;
a password comparator operable to compare a password stored in the password register with a password input from the information recording device; and
a function limiter operable to limit a function of the recording medium when the passwords compared in the password comparator do not match, and
a group password used for a predetermined group is registered in the password register and an identification ID of the group password is registered in the password related information storage.

10. The recording medium according to claim 9, further comprising:
an encryption key manager operable to manage an encryption key; and
an encryption engine operable to perform encryption of data and decryption of encrypted data by using the encryption key, wherein
the function limiter limits a function associated with the encryption or the decryption of the encryption engine.

11. The recording medium according to claim 10, wherein
the encryption key manager
disables the encryption key by clearing the password registered in the password register,
generates the encryption key by registering a password in the state that the password in the password register is cleared, and
does not update the encryption key even though the password which is already registered in the password register is changed.
